(19) United States
(12) Patent Application Publication
(10) Pub. No.: US 2004/0148860 A1
(43) Pub. Date: Aug. 5, 2004

(54) Production of hydrogen and carbon from natural gas or methane using barrier discharge non-thermal plasma

(76) Inventor: David E. Fletcher, Quebec (CA)

Correspondence Address: GEORGE J. PRIMAK, 13480 HUNTINGTON, PIERREFONDS, QC, H8Z 1G2, CA

(21) Appl. No.: 10/479,761

(22) PCT Filed: Jul. 24, 2002
(86) PCT No.: PCT/CA02/01149

(30) Foreign Application Priority Data
Jul. 25, 2001 (CA) 1 353 752

(51) Int. Cl. B01J 19/08

(52) U.S. Cl. 48/127.9; 48/61; 422/186

(57) ABSTRACT

Hydrogen and carbon are produced by decomposing natural gas or methane in a field of barrier discharge non-thermal plasma The apparatus for carrying out this process has two concentric elongated electrodes, one internal and one external, and a dielectric barrier between them, so arranged that there is a suitable gap between the internal electrode and the barrier. A high voltage pulser is connected to the electrodes and, when powered, creates the barrier discharge non-thermal plasma in the gas passing through the gap, thus decomposition this gas into its components, namely hydrogen and carbon.

### FIELD OF THE INVENTION

This invention relates to a method and an apparatus for the production of hydrogen and carbon by decomposition of natural gas or methane using a barrier discharge non-thermal plasma.

### BACKGROUND OF THE INVENTION

The emerging alternative energy industry is focussing on the use of hydrogen as a clean burning fuel for internal combustion engines, certain fuel cells and microturbines. The exhaust from these devices, when they are fuelled only by hydrogen, contains only pure water and no greenhouse gases such as carbon dioxide are produced. The hydrogen is oxidized to pure water in both combustion and fuel cell processes.

Industry leaders are predicting that hydrogen will be used extensively for both stationary electric power generation (residential, commercial, industrial) and transportation. The major fuel cell companies have focussed on developing and marketing residential systems for self-reliant power generation, and some of these (e.g. Plug Power/GE) are already marketing Proton Exchange Membrane Fuel Cells (PEMFC) that run only on hydrogen. Transportation markets for hydrogen may not be significant for several years, but they too eventually will move to hydrogen as the primary fuel.

At present, hydrogen for residential systems is made by conversion of natural gas by processes known as methane steam reformation and partial catalytic oxidation. The byproduct from these processes is carbon-dioxide—just as much as if the natural gas were simply burned in air. So, while the hydrogen fuel cell produces no greenhouse gases, the reformation process used to produce the hydrogen is a major source thereof, and there is no net environmental benefit. These reformation processes began as industrial scale systems. To meet the needs of the fuel cell producers, they have been down-scaled for residential use but are still very expensive and prone to contaminate the PEMFC catalysts, resulting in fuel cell breakdown. While other hydrogen production processes exist (coal gasification, biomass gasification, biomass pyrolysis) these are industrial in scale, and are not considered scalable for residential use. Electrolysis of water is another process of hydrogen production, but it is not yet economically viable for residential power generation.

Decomposition of methane into hydrogen and carbon black by a pyrolytic process using hot or thermal plasma produced by a plasma torch is also known in the art. For example, U.S. Pat. No. 5,997,837 describes such a process where high temperatures are generated and controllably maintained through various zones of the reactor to achieve the decomposition. Due to the high temperatures employed, such decomposition reaction has a tendency to also form higher hydrocarbons and undesirable poly-cyclical compounds, some of very high molecular weight. This is a considerable disadvantage of such high temperature processes.

Another process of pyrolysis of natural gas in gliding electric discharges, using a relatively cold, non-equilibrium plasma has been described in an article by Albin Czernichowski et al., presented at 10^{th} Canadian Conference on Hydrogen held in Quebec City on May 28-31, 2000. According to this process, natural gas is injected between knife-shaped steel electrodes in a so called GlidAric™ reactor, where an electrical discharge is produced across the flow of the gas to achieve pyrolysis of the gas. According to this method, up to 40% of the feed is converted, mostly to H₂ and C₂H₂ in a primary reaction and to H₂ and soot in a secondary reaction. This type of plasma generator is also disclosed in U.S. Pat. No. 5,711,859 for use in plasma-chemical conversion of N₂O into NOₓ.

Numerous prior art patents use non-thermal or cold plasma for various purposes. Such plasma is generated under non-thermodynamic conditions such that effective electron temperatures of over 10,000° C. may be achieved, while the bulk gas remains essentially at ambient temperature. For example, U.S. Pat. No. 5,750,823 uses such non-thermal (cold) plasma process for destruction of halohydrocarbons. Here, a surface wave of such plasma is created and used to convert halohydrocarbons to alternate chemical species.

Also, U.S. Pat. No. 5,817,218 describes a reactor using such plasma for cracking or synthesizing gases in the presence of a catalyst. This reactor has a first member which is a substantially flat stationary plate, and a second member which is a substantially flat rotatable plate arranged opposite to each other so as to form a gap between them which constitutes a gas passage where plasma is generated and the reaction takes place. This gas reactor is used particularly to purify gases discharged from factories and automobiles and to synthesize gases such as ethylene from methane, however, it does not address the possibility of producing hydrogen and carbon from natural gas or methane.

U.S. Pat. No. 6,185,930 discloses a method of reducing pollutant emission in motor vehicles with the use of non-thermal plasma, also called “barrier discharge” which is defined as a silent, dielectrically obstructed discharge taking place between two flat electrodes which can be planar or cylindrical and where the resulting electrical field leads to a spontaneous ignition of plasma. There is, however, no indication in this patent that such method could effectively be used to decompose methane into hydrogen and carbon.

### OBJECTS AND SUMMARY OF THE INVENTION

It is an object of the present invention to achieve production of hydrogen and carbon from natural gas or methane using barrier discharge non-thermal plasma.

Another object is to provide an efficient method and a suitable apparatus for barrier discharge non-thermal plasma application so as to decompose natural gas or methane directly into hydrogen and carbon.

Other objects and advantages of the invention will be apparent from the following description of the invention.

In essence, the present invention is based on the discovery that barrier discharge non-thermal plasma can be applied to natural gas or methane so as to decompose said natural gas or methane directly into hydrogen and carbon, essentially according to the equation:

CH_{4(g)}^{barrier discharge}>C₍ₛ₎+2H_{2(g)}

The dissociation reaction is endothermic, hence most of the barrier discharge plasma power will be consumed during the reaction. Carbon is produced in solid form, essentially as carbon black or soot It can be used in the manufacture of tires, in metallurgy, or the like.

When reference is made herein to “barrier discharge non thermal plasma”, it means a plasma generated under non-equilibrium conditions and based on the principle of a dielectrically obstructed discharge of electrical pulses between a pair of electrodes. A good definition of such plasma is given, for example, in U.S. Pat. No. 6,185,930 which has already been mentioned above.

The preferred method for producing hydrogen and carbon from natural gas or methane, in accordance with this invention, comprises:

(a) passing a thin layer of natural gas or methane in a gap between two elongated concentric electrodes containing a dielectric barrier between them; and

(b) producing a discharge of electrical pulses within said gap between the dielectric barrier and one of the electrodes so as to create a barrier discharge non-thermal plasma in said gap adapted to decompose natural gas or methane into hydrogen and carbon.

Solid carbon can then be separated from hydrogen by filtration or by using a negatively charged electrode to which the carbon is attracted because it carries a positive charge, and the two products can be collected and stored in separate containers. For example, hydrogen which is in gaseous form, can be transformed into a metal hydride as is known in the art and stored in such form.

The apparatus of the present invention comprises an elongated reactor having two concentric elongated electrodes, one internal and one external, and containing a dielectric barrier between them and having between the barrier and the internal electrode, a narrow gap in which natural gas or methane is adapted to flow. The internal electrode is preferably rotatable and driving means are provided to rotate it at predetermined speeds which could be up to 20,000 rpm, or even higher. The surface of the internal electrode is preferably provided with recesses or grooves, for example in the form of an auger, providing a high surface area for the plasma and thereby facilitating the chemical reaction.

The dielectric barrier can be made of a suitable dielectric material that may be metallized on the outside or otherwise connected to a metallic electrode. Preferred dielectric materials are ceramics with a high dielectric constant in the range of about 80-20,000. Such materials with a high dielectric constant are referred to in U.S. Pat. No. 3,954,586 where they are used in a corona generator for ozone production. It is stated in that patent that the higher the relative dielectric constant of the dielectric material, the greater the ozone output per unit of dielectric area for a given voltage and dielectric thickness. It has been surprisingly found that a similar relationship applies to the production of hydrogen using a barrier discharge non-thermal plasma in accordance with the present invention. Thus, to optimize the production of both hydrogen and carbon, it is preferable to use dielectric materials with a high dielectric constant as the dielectric barrier in the apparatus of the present invention.

One arrangement of the concentric electrodes in the apparatus of this invention may be cylindrical, in which case the gap between the electrodes is constant in size. Another arrangement may have a frustoconical or inclined design of the electrodes, in which case the gap could be made of variable size. The gap between the electrodes is pre-set taking various parameters into consideration, including the dielectric constant referred to above, however, it is usually very narrow, normally between about 0.25 mm and 4 mm wide. This gap will normally be adjusted to provide optimum conditions for the decomposition of natural gas or methane into hydrogen and carbon by the barrier discharge non-thermal plasma in accordance with the present invention. The power of such plasma is determined by a number of factors, such as the applied voltage, the dielectric constant and the thickness of the dielectric barrier material, and the applied frequency.

The apparatus of the present invention also comprises a high voltage electrical pulser (a power supply that produces electrical pulses) which is connected to the electrodes and produces in the gap between them a state of plasma that contains millions of minute electrical discharges which break the molecular bonds between hydrogen and carbon, thereby leading to the dissociation of the natural gas or methane. Preferably, pulsers are used which are capable of producing bi-polar electrical pulses that excite the plasma gases. Such pulsers are known in the art.

For the purposes of the present invention, the pulser normally operates at voltages of 5-15 kV or higher and the strength of the dielectric barrier must be capable to withstand such voltages and the plasma temperatures produced thereby.

To optimize the reaction within the gap, the natural gas or methane may be pre-heated to temperatures of about 250-300° C. and thus the apparatus of the present invention may be provided with means for achieving such pre-heating. If surplus heat is generated during the dissociation reaction, it may be used for the pre-heating mentioned above. The apparatus may also be provided with sensors and/or monitors of various kinds, such as inlet gas temperature sensor, outlet gas temperature sensor, dielectric barrier temperature sensor, inlet flow rate monitor, outlet flow rate monitor, rotation flow rate sensor, hydrogen sensor at the outlet, and so on. A suitable computerized control may also be provided with commands to control the flow rate of the input gas, the rotation of the internal electrode, the pulser operation (frequency, voltage, pulse width), the temperature of gas pre-heat, and the like.

### BRIEF DESCRIPTION OF THE DRAWINGS

Some preferred, non-limitative embodiments of the present invention will now be described with reference to the appended drawings in which:

FIG. 1 is a graphical elevation view of an apparatus in accordance with the present invention;

FIG. 2 is a cross-sectional view along line A-A of FIG. 1;

FIG. 3 is a detail view of an arrangement of electrodes with a barrier in between, in the apparatus of the present invention;

FIG. 4 is a detail view of another arrangement of electrodes with a barrier in between, in the apparatus of the present invention; and

FIG. 5 is a pictorial representation of a basic design of a plant for the manufacture of hydrogen and carbon from natural gas in accordance with the present invention.

### DETAILED DESCRIPTION OF THE PREFERRED EMBODIMENTS

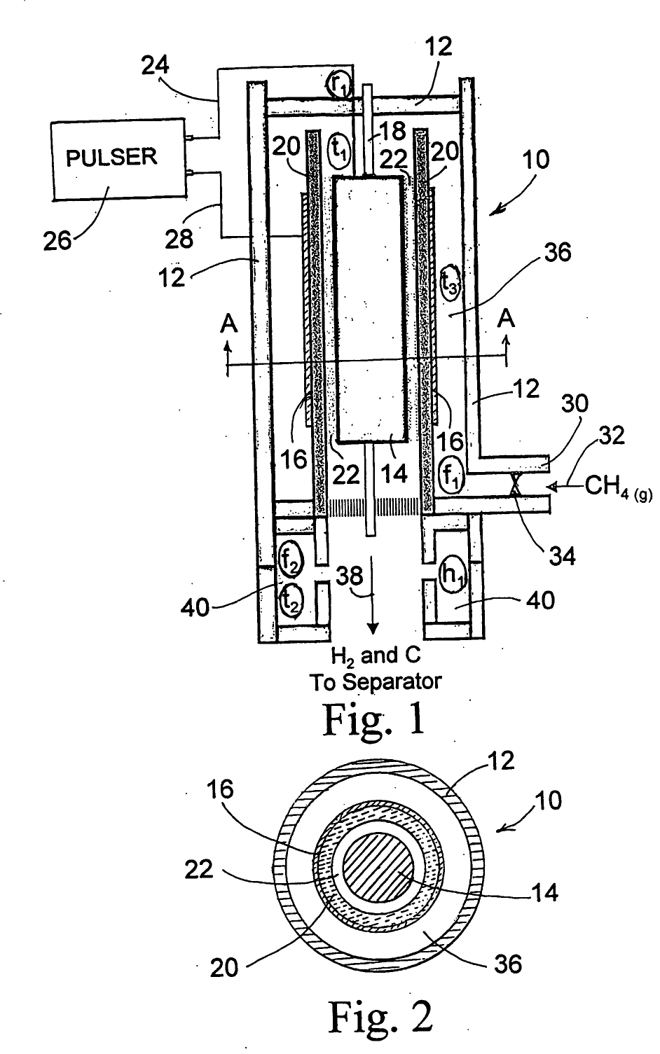

In the drawings in which the same elements are designated by the same reference numbers, FIG. 1 illustrates an apparatus 10 that can be used for the purposes of the present invention. The apparatus 10 comprises an outer casing 12 forming a gas-tight outer housing inside of which are mounted two concentric electrodes, namely the internal cylindrical electrode 14 and the surrounding external electrode 16. These electrodes 14 and 16 are made of a conductive material, such as stainless steel. The internal electrode 14 is mounted on a shaft 18 which is preferably rotatable. Between electrodes 14 and 16, there is provided a barrier 20 of dielectric material which is connected to the inner surface of the electrode 16, for example by metallization of said surface with an electrically conductive material. There is a gap 22 between the barrier 20 and the electrode 14 where the decomposition reaction takes place. The inner electrode 14 has a high voltage connection 24 to a pulser 26 which also has an earth connection 28 to the outer electrode 16, or vice versa.

The apparatus 10 has an inlet 30 by which natural gas or methane flows into the reactor as shown by arrow 32. The inlet 30 is provided with a flow rate regulator valve 34 to regulate the gas flow into the apparatus. If desired, the gas flowing into the apparatus may be pre-heated in the concentric chamber 36 by suitable heating means (not shown). After transformation of CH₄ into H₂ and C, these products leave the reactor as shown by arrow 38 and proceed to a separator (not shown) and storage.

The apparatus may also be provided with a number of sensors or monitors, such as:

f₁—inlet flow rate monitor

f₂—outlet flow rate monitor

h₁—hydrogen sensor

r₁—rotation rate sensor

t₁—gas inlet temperature sensor

t₂—outlet gas temperature sensor

t₃—temperature sensor of the barrier

Sensors h₁, f₂ and t₂ may be conveniently placed in an outlet enclosure 40. Other sensors or monitors may be provided if required for a proper control of the reaction.

FIG. 2 illustrates the concentric design of the apparatus 10, showing the arrangement of internal electrode 14 and external electrode 16 between which there is provided the ceramic barrier 20 and the gap 22 where the reaction takes place. All this is enclosed within a gas-tight outer casing 12 which provides the gas conveying chamber 36 where the natural gas or methane can be pre-heated prior to penetrating into the gap 22.

The operation of the apparatus 10 illustrated in FIGS. 1 and 2, which represents the method of the present invention can be described as follows:

Natural gas or methane (indicated in FIG. 1 as CH₄ gas) is introduced into the apparatus 10 by inlet 30. Its flow can be regulated by valve 34. The CH₄ gas can be preheated in the chamber or enclosure 36 to a temperature of about 250-300° C., if desired. The CH₄ gas then flows within the gap 22 between electrode 14, which is preferably rotated on shaft 18, and barrier 20 of a dielectric material, such as a ceramic of high dielectric constant, connected to the outer electrode 16. The ceramic tubular wall 20 may have a thickness of 0.5 mm to 4 mm. Preferably this thickness should be minimized while maintaining the required strength of the wall. Pulser 26, operating at 5-15 Kv, is connected by a high voltage connection to the internal electrode 14 and by an earth connection to the outer electrode 16 or vice-versa. When it is powered, it generates streams of pulses in gap 22 forming a barrier discharge non-thermal plasma with millions of electrical discharges which dissociate the CH₄ gas molecule into its hydrogen and carbon components.

The various parameters, such as the configuration of the electrode, the type and thickness of the barrier material, the size of the gap where the reaction takes place, the power supplied by the pulser, the temperature and the flow rate of the gas flowing in the gap and the speed of rotation of the internal electrode, may be computer controlled to optimize the conversion reaction and thus the production of hydrogen and carbon from natural gas or methane.

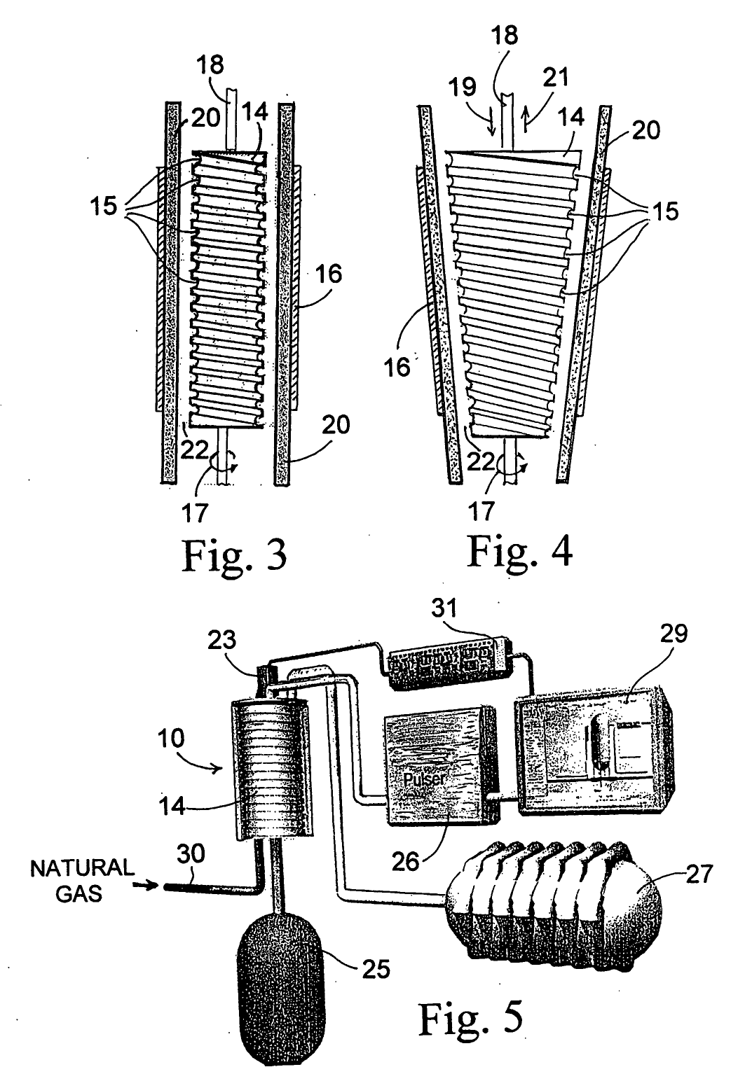

In a preferred embodiment illustrated in FIG. 3, the configuration of the internal electrode 14 is shaped as an auger. This provides the surface of the electrode 14 with a continuous groove 15 throughout the length of the electrode. The size and contour of the groove may be adjusted for best reaction conditions. For example, the depth of the groove 15 could be about 2-3 mm. The internal electrode 14 is rotated on its shaft 18 as shown by arrow 17 using suitable drive means. The rotation could be at 3000-5000 rpm, although higher rotation speed can also be used. Groove 15 increases the reaction surface area and the resulting screwing action insures that the gas mixes intimately with the plasma. The gap 22 between the grooved internal electrode 14 and the ceramic barrier 20 is in this case constant, namely, once established, it cannot be varied without re-constructing the entire reactor core. However, in the frustoconical arrangement shown in FIG. 4, the size of the gap 22 may be adjusted by merely moving shaft 18 up or down as shown by arrows 19 and 21, thus moving the electrode 14 likewise, thereby changing the size of the gap. Otherwise, the design is the same as in FIG. 3.

FIG. 5 illustrates a basic plant arrangement based on the method and apparatus of the present invention. It shows the apparatus 10 with its internal grooved electrode 14 rotated by motor 23 and operating with a barrier discharge non-thermal plasma as described with reference to FIG. 3. Pulser 26 provides the power for the plasma creation. Natural gas is introduced into inlet pipe 30 and is decomposed in the apparatus 10 into hydrogen and solid carbon which is stored in the carbon storage container 25, whereas hydrogen can be conveyed to storage container 27 where it may be stored in the form of a metal hydride. It could also be liquefied or compressed or be directly used in a fuel cell, etc.

A computer 29, with proper software, is used to control the operation through a data collector 31 to which information from the various sensors and monitors is conveyed. The computer 29 uses these signals to adjust the operation of the pulser 26 and other parameters according to a predetermined program, so that said parameters are kept within predetermined values.

This type of hydrogen production is well adapted to take place at the point of use of the produced hydrogen, replacing costly compression and liquefaction based systems required to distribute hydrogen by vehicles from remote production facilities.

The invention is not limited to the specifically described embodiments, but many modifications obvious to those skilled in the art can be made without departing from the invention and the following claims. For example, by properly designing the gap where the reaction takes place and providing suitable power from the pulser, the methane dissociation can be optimized by forcing essentially all unreacted gas to pass through the gap. Also, by designing the internal electrode like an auger with a continuous groove, such electrode becomes a screw driving the gas in the gap toward the dielectric barrier, where the plasma is strongest, and pushing the gases and the carbon particles towards the outlet. Also, by designing the auger to be slightly v-shaped, the gaseous gap may be dynamically controlled, allowing for precise adjustments of the plasma power through the small modulations of the gaseous gap.

A person skilled in the art will be in a position to optimize the operation of the process and apparatus of the present invention by adjusting and controlling the various parameters discussed above.

1. Method of producing hydrogen and carbon which comprises subjecting natural gas or methane to the action of barrier discharge non-thermal plasma so as to decompose said natural gas or methane directly into hydrogen and carbon which constitute the two products of the process.

2. Method according to claim 1, wherein the natural gas or methane is subjected to the action of the barrier discharge non-thermal plasma by passing a thin layer of said natural gas or methane in a gap between two elongated concentric electrodes containing a dielectric barrier between them and by producing a discharge of electrical pulses within said gap between the dielectric barrier and one of the electrodes thereby creating said barrier discharge non-thermal plasma in said gap, adapted to decompose the natural gas or methane dinky into hydrogen and carbon.

3. Method according to claim 2, wherein said natural gas or methane is subjected to intimate mixing with plasma while passing through said gap.

4. Method according to claims 1, 2 or 3, wherein said natural gas or methane is preheated to a temperature of about 250-300° C. prior to being subjected to the action of the barrier discharge non-thermal plasma.

5. Method according to any one of claims 1 to 4, further comprising separating the carbon from the hydrogen and collecting then in separate storage vessels.

6. Apparatus for producing hydrogen and carbon from natural gas or methane, which comprises:
(a) an elongated gas-tight casing having two concentric elongated electrodes, one of which is an internal electrode mounted substantially in the longitudinal center of the casing and the other electrode is an external electrode mounted concentrically around the internal electrode;
(b) a concentric dielectric barrier connected to the external electrode so as to form a gap between said internal electrode and said barrier, said barrier and said gap being adapted to produce and maintain a barrier discharge non-thermal plasma within said gap suitable for decomposing the natural gas or methane directly into hydrogen and carbon;
(c) means for passing the natural gas or methane through said gap; and
(d) a high voltage pulser connected to said electrodes for creating the barrier discharge non-thermal plasma within said gap which is suitable for decomposing the natal gas or methane directly into hydrogen and carbon which constitute the two products produced by the apparatus.

7. Apparatus according to claim 6, wherein the internal electrode is cylindrical.

8. Apparatus according to claim 6, wherein the internal electrode is frustoconical.

9. Apparatus according to claim 6, 7 or 8, further comprising means for rotating said internal electrode at a predetermined speed.

10. Apparatus according to any one of claims 6 to 9, wherein the internal electrode is provided with a continuous groove over its surface, forming a screw-like design.

11. Apparatus according to a one of claims 6 to 10, wherein said dielectric barrier is formed of a ceramic material having a dielectric constant been about 80 and 20,000.

12. Apparatus according to any one of claims 6 to 11, wherein the dielectric barrier has a thickness of about 0.5-4 mm.

13. Apparatus according to any one of claims 6 to 12, wherein the gap between the internal electrode and the dielectric material is between about 0.25 and 4 mm wide.

14. Apparatus according to any one of claims 6 to 13 wherein the high voltage pulser is capable of producing bi-polar electrical pulses.

15. Apparatus according to any one of claims 6 to 14, further comprising a separator for separating solid particles of carbon from hydrogen after these products have been formed.

16. Apparatus according to any one of claims 6 to 15, further comprising sensors and/or monitors of operating parameters within the reactor, and a computerized control to adjust and control said parameters within predetermined values.
